(19) United States
(12) Patent Application Publication
(10) Pub. No.: US 2010/0227204 A1
(43) Pub. Date: Sep. 9, 2010

(54) Concentration cell energy storage device

(76) Inventor: Ralph Zito, Port Orange, FL (US)

Correspondence Address: BURNS & LEVINSON, LLP, 125 SUMMER STREET, BOSTON, MA, 02110, US

(21) Appl. No.: 12/381,006

(22) Filed: Mar. 6, 2009

(51) Int. Cl. H01M 6/24; H01M 4/66

(52) U.S. Cl. 429/50; 429/245; 429/188

(57) ABSTRACT

A method and apparatus for the accumulation and storage of energy in electrically reversible manner wherein a two chamber electrochemical cell(a single one or part of an array of such cells) has an electrolyte of common specie solutions in the multi-chambers associated with cell electrodes and application of voltage to the electrodes causes dissimilar concentrations of ions in two chambers so that the energy is stored and reversing polarity of the electrodes allows energy discharge and normalization of concentration. Materials may be reversibly stored in the cell as solids when exceeding the solubility limits of the electrolyte, such storage being done preferably at porous electrode surfaces.

### FIELD AND BACKGROUND OF INVENTION

The present invention relates to electrochemical energy storage and delivery devices.

The need for a practical energy storage device is by now obvious to everyone. To date there is no inexpensive, reliable and light weight method of storing energy for use at a later time. Methods such as compressed air, metal springs, flywheels, and even batteries are too heavy, complex, unreliable and generally have short lives or high maintenance.

Also, at present, there is no inexpensive means of storing energy for use in automobiles. The hybrid electric car presently employs lithium-ion cells for storage. However, they are too costly to provide a useable driving range, and are too heavy for practical use.

The same situation exists regarding storage of large quantities of energy generated by wind mills, solar cells, or even hydroelectric plants for later use. This state of affairs continues to motivate me to search for a possible solution. Energy in electric form is the most useful and efficient. That suggests electrochemical batteries—still the only known hope.

Heat engines are notoriously inefficient, and usually complex and involve many moving parts requiring high maintenance. Electrochemical processes are usually simple, very efficient, and involve no moving parts. Hence, their attractiveness as a means of storing energy. This energy is stored either at the factory when the primary battery is fabricated, or charged electrically during use as a secondary battery such as the well-known lead-acid battery.

Despite their physical simplicity, batteries do have life limiting problems. Most batteries involve the electro-deposition of different solid materials on electrodes. Batteries fail because the internal processes are not reversible in any practical sense. The irreversibility is primarily due to the fact that there are dissimilar materials on either side of the cell, and that the reactions themselves are not truly reversible, and that there are physical changes as well within the cell that are also not reversible upon cycling.

### SUMMARY OF THE INVENTION

This invention is an electrochemical system for the storage of energy with essentially no irreversible inherent processes necessary to its operation that would result in inexorable deterioration of performance. The energy is stored in the form of concentration differences of a single chemical substance at opposite electrodes within an electrochemical cell. That substance is readily ionized and reduced or oxidized at the electrodes upon demand. The main performance goals are very long operational life, reproducibility and dependability of performance as well as low cost. Application possibilities considered are the electric hybrid car, emergency and portable power, load leveling for solar, wind and hydro sources. Problems normally associated with solid reagent materials in secondary electrochemical cells are virtually eliminated in this invention. And since the chemical environment is mild, there is deterioration of electrodes or other internal cell components. Any non-uniformity of electrolytic depositions in electrode surfaces during cycling is self-correcting.

These cells make use of the colligative properties of matter. Potentials result from differences in concentration of the same chemical specie at different oxidation states. The potentials do not result as a consequence of energy level differences of couples of dissimilar materials. The processes are analogous to the compression of a gas where energy is stored in mechanical form by creating significant concentration differences between the same molecular substances. i.e., pressure differences between the inside and outside of a pressure vessel.

Sulfur (soluble as polysulfides in solution) and sulfide as well as ferric and ferrous ions are attractive examples. Thus we can have very high concentrations of sulfide ions on one side of a cell and very low concentrations on the other to produce an electric potential. The present invention provides a way to establish a very large concentration ratio between the two. That can be accomplished by storage of the sulfide ions and within a very small volume in the interstitial spaces of a microporous electrode such as activated carbon.

However, one must prevent these ions in the form of an alkali sulfide in solution from diffusing quickly from the high to the low concentration sides of the cell. A microporous or cation exchange membrane serves that purpose well—but not quite well enough. The present invention will store the major portion of the reagents, i.e., sulfur and sulfides as solids that have exceeded their solubility and are deposited within the porous electrodes for cycling. These solids will not diffuse through the electrolyte, hence achieving a fairly high charge retention, and much higher capacity for charges within the cell. These solids will go into solution, or precipitate out of solution at flow. These solids will go into solution, or precipitate out of solution at acceptable rates when demands are made at the electrode surfaces in the form of electrical current flow. The result produces a cell that is truly reversible and symmetrical in terms of materials. Also, the cell materials concentration can be controlled entirely electrically with no need for mechanical flow of fluids, etc. The failure modes of such a concentration cell are indeed minimal.

Energy input to the cell is in the form of electric voltages and current in much the same fashion as for batteries. The output also is not mechanical, but rather in the convenient form of voltages and currents. The agents for such energy storage purposes are a selected molecular species. At full charge, the agents are stored within electrodes structures in very concentrated form at one side of the cell while the same agent is stored at very low concentrations within the opposite electrode structure. This mechanism is suggestive of a two-vessel compressed air device with one tank at very high pressure and the other at very low pressure

In the this invention the molecular agents that are stored are the same species but at different electrical excitation or oxidation states, thus enabling one to store the energy and obtain it in return in entirely electrical forms. No mechanical high pressures and no moving parts are required. There is no storage of electrical charge as such as there is in an electrical capacitor.

Many variations of this new system are possible. In the FIG. 1 diagrams cell in the charged state. The molecular components which can exist as molecules with zero electric charge, or as ions with single or multiple electrical charges. They are identified here as species A and B making up the soluble compound (electrolyte) AB. Specie B is the “active’ material undergoing oxidation and reduction. Specie A always remains in the same ionized state, and merely maintains and serves as a charge carrier. They also form compounds with each other. Specie A is considered mobile as an ion, and specie B is treated as less mobile and relatively fixed within the electrode region as shown. The balance of electrical charges on either side of the cell is zero, and hence the cell itself has zero net charge at any stage of operation. In the charged state the entire electrode region has B in the ionic state—with an equal number of oppositely charged species A on the same cell side. The opposite cell side has all of the specie B in the zero charged state (molecular), and the number of A species is [symbol] correspondingly less to give a net charge for that side equal to zero. This is the stage of [symbol] maximum order and useful work can be extracted from the cell by discharging to maximum disorder.

If one designates N as the number of respective materials per unit volume of cell, respectively, as shown below, the cell at full charge has total of 4N components with 2N on each side as diagramed below.

N(AB)+N(B)∥N(AB)+N(B)

Upon charging to full capacity the cell will have a distribution of components as shown below.

2N(B)∥2N(AB)

Depending upon the solubility of the various components, some portion will be in solution while the remainder will be in solid form within the porous carbon electrodes.

The electric potential of the cell will be proportional to only the concentration ratios of the ionic species in solution that are undergoing oxidation and reduction. In this example the B specie only is experiencing oxidation and reduction. Hence, only the concentrations of the B⁻ ion in solution will contribute to the cell voltage. The amount of the reagents AB and B in the solid state within the porous carbon is stored for later use as they are dissolved into the electrolyte during the cycling process.

FIG. 2 shows the cell in the discharged state with the same number of charged B specie as discharged, and the opposite electrode region has an identical charge distribution, and no further useful work can be performed.

The following is a description of the principal aspects of a concentration cell as configured in this invention, and is in the form of a device where the internal charges are ions in “solution”.

There are few chemical elements and compounds that lend themselves well to such processes. The active material chosen as representative of this class of device employs sulfur as both oxidizer and reducer.

In addition to treating the diffusion rates through a separator into an out if the bulk storage regions, the rates of adsorption/desorption must be taken into account. As a first approximation let us use the expression by Langmuir regarding adsorption isotherms. This approximation does not account for changes in adsorptivity as the surface sites become more occupied, and that the ratio of the coefficients αₐ and α_{d} the adsoption and desorption in the relationships below is constant.

Rate of adsorption=αₐ(1−θ) C

Rate of desorption=a_{d}θ

where C is the concentration of the specie in solution being adsorbed, the adsorbent, and θ is the fraction of the total available sites that are occupied by adsorbent at point in time.

The introduction of this new term changes not only the mathematical balance equations, but also the very nature of the mechanisms of storage. Now, the electrode is no longer just seeing the concentration of specific ions in the surrounding bulk electrolyte, but it primarily sees the concentration of the adsorbed ions readily available at the electrode surface. So, it becomes necessary to modify the model and our thinking about what may be happening within the cell.

The rates are as follows;
R_{g}=K_{g}I=generation rate of S⁼ ions, always at the (−) electrode
Rₛ=adsorption rate=α₁(1−θ) C
R_{d}=desorption rate=α_{d}θ

$${R}_{m} = diffusion rate across the membrane = \frac{{K}_{m}}{V} ( 2 {Q}_{1} - {Q}_{o} )$$

The net rate, Rₙₑₜ, of increase of the reagent (specie) may be expressed as a sum of differentials where (dQ/dt)ₙₑₜ is positive if Q is increasing with time, or

$${( \frac{d Q}{d t} )}_{net} = {( \frac{d Q}{d t} )}_{g} - {( \frac{d Q}{d t} )}_{m} - {( \frac{d Q}{d t} )}_{s} + {( \frac{d Q}{d t} )}_{d}$$

FIG. 3 is a diagram of the “compartmentalized” nature of the cell with the “Helmholtz” region being essentially what the electrode sees, and is the concentrated electrolyte in dynamic equilibrium with its solid forms on the surfaces of the porous electrodes. This region of electrolyte is also in dynamic equilibrium with the bulk electrolyte occupying the volume between the electrodes and the separator membrane. The bulk concentration differentials across the separator determines the diffusion rate of soluble components, e.g., sulfur complexed with sulfides and sulfide ions from one side of a cell to the opposite side. However, the loss rate, (dQ/dt)_{diff} of specie of interest (Helmholtz) by diffusion to the bulk electrolyte on the same side of the membrane is of greatest concern here.

Low solubility versus high salt solubility is an interesting issue because we want salts to go into solution fast to sustain higher cell currents during discharge, but to also precipitate out of solution during charge and for higher charge retention. Now, the expression for the net rate of change of concentration of active specie most proximate to electrode surfaces during charging becomes

$${( \frac{d Q}{d t} )}_{net} = {( \frac{d Q}{d t} )}_{g} - {( \frac{d Q}{d t} )}_{diff} - {( \frac{d Q}{d t} )}_{s} + {( \frac{d Q}{d t} )}_{d} - {( \frac{d Q}{d t} )}_{p} + {( \frac{d Q}{d y} )}_{rs}$$

The terms with subscripts g, s, d, p and rs represent generation, sorption, de-sorption, precipitation and re-solubilization of precipitated specie.

There are the balances between the rates of de-sorption as well as solubilization of precipitated reagent, in this case, Na₂S.

The rates of sorption, and diffusion are placed in the loss category since they represent losses from the (−) electrolyte. And, the desorption along with the electrical generation rates are to be considered gains, or sources of S⁼ ions to the (−) electrolyte. In this fashion we can handle the ensuing balance equations. Thus, the net rate, R, into the (−) electrolyte is now

R=R_{g}+R_{d}−Rₛ−Rₘ

More specifically the above becomes

$$R = {K}_{a} I - {α}_{a} ( 1 - θ ) {C}_{1} + {α}_{d} θ - \frac{{K}_{m}}{V} ( 2 {Q}_{1} - {Q}_{0} )$$

The most important parameters for optimum cell operation are;
1. Maximize energy capacity by increasing amount of charge density per unit area of electrode.
2. Establish high and sustainable concentration ratios of ionic components, i.e., large concentration at the (−) electrode and small concentration at the (+) electrode.

One way to enhance charge capacity while reducing diffusion losses is to make use of solid precipitates. If the solubility of the sulfide compounds is exceeded they will precipitate out of solution, and by design onto the surfaces of the electrodes. This provides for additional supply of reagents, and in a form that will remain within the (−) and (+) cell compartments for longer periods of time.

If we stipulate a simple linear relationship between the solution and dissolution (re-solubilizing) rates for the solid sulfur, and polysulfides that fall in and out of solution, we can express this additional factor as follows.

Let Rₚ₁, and Rₚ₂, be the rates with which the compounds are precipitated and dissolved as

Rₚ₁=β₁(C₁−Cₛ)

Rₚ₂=Pβ₂

where β₁ and β₂ are constants at any given temperature, and C₁ is the concentration of the S⁼ ions in solution, and P is a constant associated with the amount of solid Na₂S in solid precipitate form. The term Cₛ is the maximum concentration that the electrolyte will tolerate prior to “salting out”. This last term is not a constant and tends to be very dependent upon conditions such as temperature, presence of suspended solids, etc. The concentration tendencies C₁ somewhat above Cₛ will drive the precipitation of material out of solution. We can assume for sake of simplicity that the relationships are linear.
Thus, the equation for the complete, net rate, R, takes the form

$$R = {K}_{α} I - {α}_{α} ( 1 - θ ) {C}_{1} + \frac{{K}_{m}}{m} ( 2 Q 1 - {Q}_{0} ) + ( {C}_{1} - {C}_{s} ) {β}_{1} + P {β}_{2}$$

The net quantity of interest to us at the end of charging is the amount of S⁼ ions available for discharge. That is found by equating the input rates and loss rates at dynamic balance for any charging current, I, as the maximum achievable charge. And, that is when R=0, or when

$${K}_{a} I + {α}_{d} θ + P {β}_{2} = {α}_{a} ( 1 - θ ) {C}_{1} + \frac{{K}_{m}}{V} ( 2 {Q}_{1} - {Q}_{o} ) + ( {C}_{1} - {C}_{s} ) {β}_{1}$$

Our main interest in the above derivations is the evaluation of the amount of species, Qₐ, adsorbed within the electrode. In this case it's the sulfide ion in the form of the compound sodium sulfide. (ions cannot be adsorbed as such without the accumulation of an inordinately high electrical charge)

It is necessary then to put θ into terms of quantity of material rather than the ratio of occupied to total available sites. This is easily accomplished as follows.

If we let A=the total number of available sites (per unit electrode volume), then the factor (1−θ) can be replaced in terms of A.

$$\frac{A - {Q}_{a}}{A} = 1 - \frac{{Q}_{a}}{A} = 1 - θ , then the adsorption rate is$$

$${R}_{a} = {C}_{1} {K}_{a} [ \frac{A - {Q}_{a}}{A} ]$$

The only explanation for the magnitude of voltages obtained from our experimental cells is that the mechanism of “electro-adsorption” or its equivalent is taking place. That would necessitate a small layer of “stagnant” electrolyte at the electrode porous surfaces. This layer might be thought of as a cloud of very dense layer, δ, of concentrated specie (S⁼ ions) about to be adsorbed. The balanced rate equation is thus modified to reflect this micro-layer assumption as

$${K}_{a} I + {α}_{d} θ + P {β}_{2} = {α}_{a} ( 1 - θ ) {C}_{δ} + \frac{{K}_{m}}{V} ( 2 {Q}_{1} - {Q}_{o} ) + ( {C}_{δ} - {C}_{s} ) {β}_{1} ,$$

where C_{δ} is the concentration of S⁼ in the immediate neighborhood of the electrode and precipitate surfaces.
Substituting the expression for θ in terms of Qₐ, the amount adsorbed, we get

$${K}_{a} I + {α}_{d} \frac{{Q}_{a}}{A} + P {β}_{2} = {α}_{a} ( 1 - \frac{{Q}_{a}}{A} ) {C}_{δ} + \frac{{K}_{m}}{V} ( 2 {Q}_{1} - {Q}_{o} ) + ( {C}_{δ} - {C}_{s} ) {β}_{1}$$

The time delay between adsorption and generation by electric current and charge transfer largely gives rise to this thin δ layer of perhaps not much more than a number of molecular diameters, or mean free paths in thickness.

It is very important to the successful operation of such concentration cells regarding their practical application that the capacity and charge retention is not entirely, or even largely, dependant upon membrane characteristics because we would be engaged in the ever continuing compromises between electrical conductivity and diffusion coefficients of such materials. Virtually everything that is done to reduce separator electrical resistance also promotes molecular diffusion. Hence, we seek mechanisms wherein molecular species can be collected to very high concentrations by some sort of bonding or retardation process, while not significantly detracting from either the cell potential or ionic mobility. The membrane serves the purpose mainly of keeping the two bulk electrolytes apart. A high effective concentration of the ionic specie of interest (the S⁼ ion in this instance) must be established and maintained though out the charging process in order to “force” the diffusion of that ion into the carbon surfaces to be adsorbed. A gelled electrolyte might very well serve that purpose. Some of our experimental results have shown that excellent operation can be obtained with only a gelled electrolyte to immobilize the substances. However—it is necessary to pay attention to the mechanism of electrode starvation when employing gels because the S⁼ ion can be depleted in the δ layer resulting in high resistance and little charge transfer.

This invention can provide, usefully, some or all of the following benefits in particular usages:
a. a static system for the storage of energy in electrical form;
b. energy stored within an electrochemical cell where the active materials are the same on both sides thus eliminating problems of irreversible deterioration of cell via accumulation of undesired substances on the cell sides;
c. all materials have some solubility enabling all solids that are formed during the cycling processes to be returned to new and uniform positions within the cell;
d. ionic, energy storing components are stored within electronically conductive, high surface area pores of electrodes thus enabling high coulombic capacity.
e. to further increase coulombic capacity active materials are stored in quantities exceeding their solubility in the electrolytes; These precipitated components are deposited and stored also within the pore structure of electrodes so that they may be readily available for re-solubilization and subsequent participation in the electrolytic, energy producing reactions.
f. to obtain and maintain high electric potentials, the concentrations of reducing and oxidizing agents are replenished by the respective precipitation of components; An example of this is during the discharge mode of a cell at the positive electrode as the sodium ions arrive the sulfur stored in that electrode is solubilized and generates sulfur ions in association with the newly arrived sodium ions thus maintaining a high sulfide ion concentration within the close (Helmholtz) region to contribute to call voltage. A similar, but opposite process takes place at the negative electrode where solid sodium sulfide salt is precipitated out of solution.
g. all active components are electronically non conductive to prevent internal short circuit situations;
h. all processes are completely reversible and will go to completion; and
i. conductivity of electrolyte, and solubility of components can be altered to promote performance by the addition of other solutes.

Other objects features and advantages will become apparent from the following detailed description of preferred embodiments taken in conjunction with the accompanying drawings in which:

### BRIEF DESCRIPTION OF THE DRAWINGS

FIGS. 1-3 are cell schematics as described above;

FIG. 4 is a plot of results of a bench test on a simple cell;

FIG. 5 is a diagram of a typical cell embodiment, and

FIGS. 6-9 are plots of results of tests described in examples 1, 2 et seq. below; and

FIGS. 10-14 show construction of preferred embodiments of the invention.

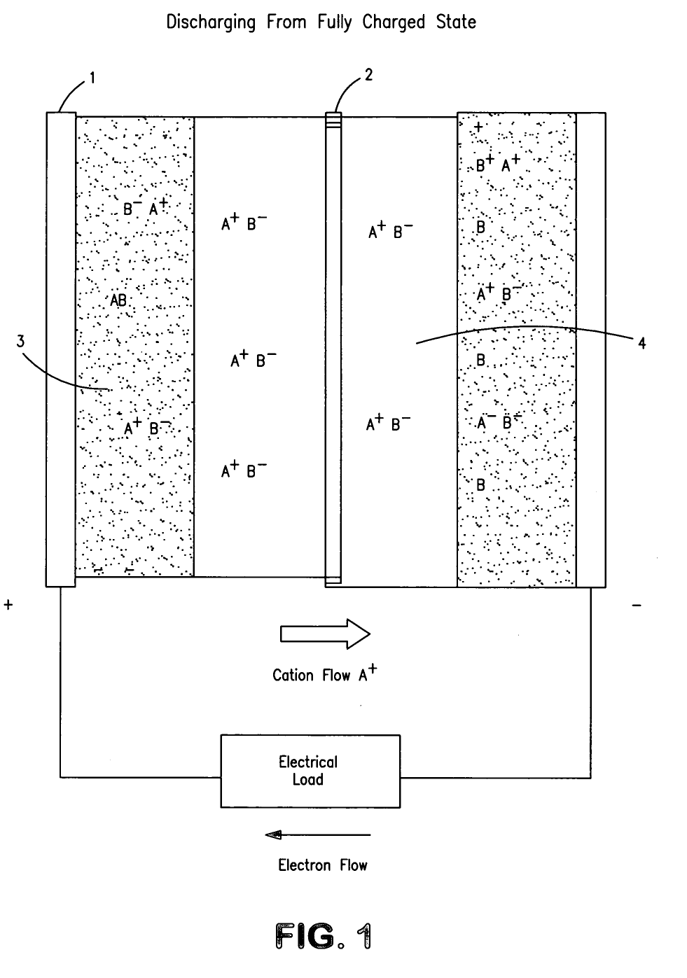

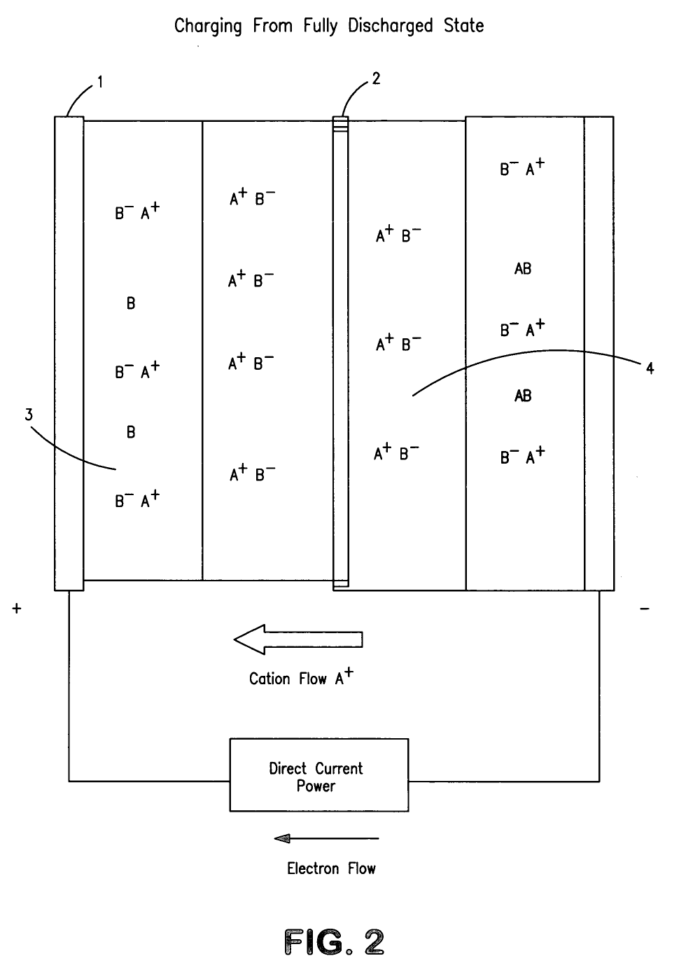

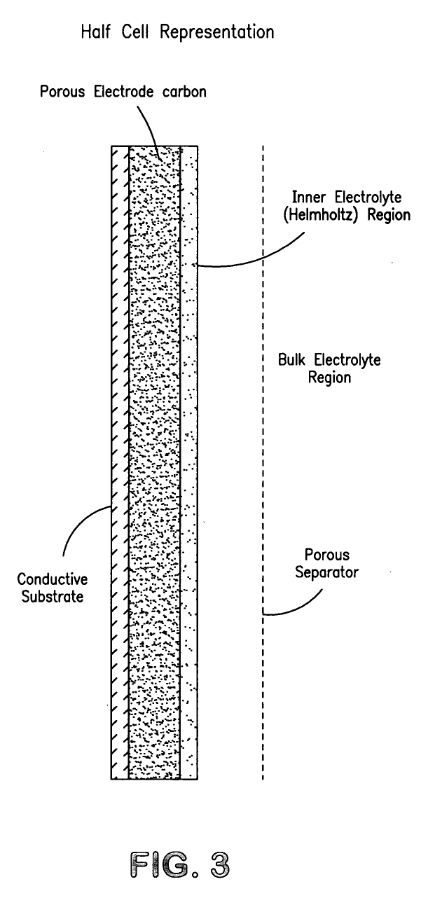

### DETAILED DESCRIPTION OF PREFERRED EMBODIMENTS

### Empirical Performance Characteristics

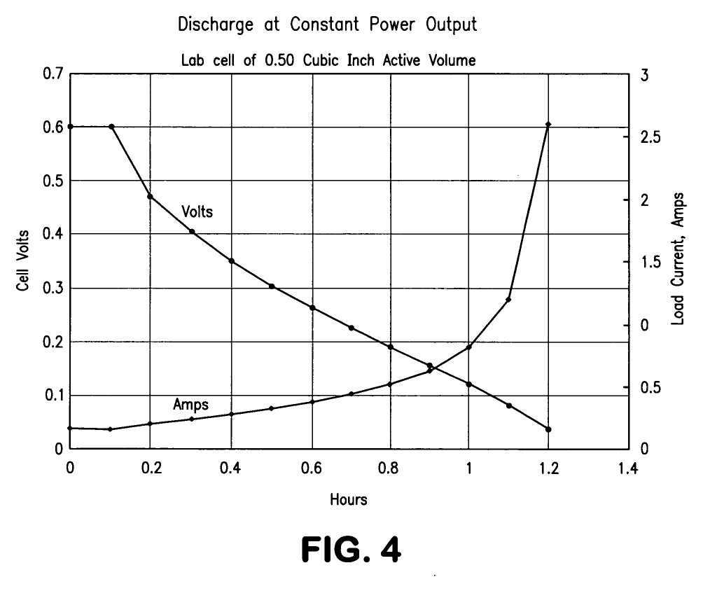

The plot shown in FIG. 4 is a typical test bench result for a small engineering sulfide/sulfur cell with electrode area of 10 square inches. It illustrates the very basic performance of a system being discharged at constant power where the potential with which the energy is delivered is directly proportional to the energy remaining in the system. The curve is for the discharge mode of operation at constant power delivery to a load. Total charge capacity of the cell in this instance is about 0.40 amp-hour. Voltage and current are continuously changing to maintain constant power at 0.10 watt. External power management circuits are employed to achieve this type of performance.

### Sulfide/Sulfur Half Cell Balance

The information contained in the following text, graphs and mathematical development concerns the properties specific to a symmetrical electrochemical cell employing the basic and reversible reaction

S+2e [symbol] S⁻²

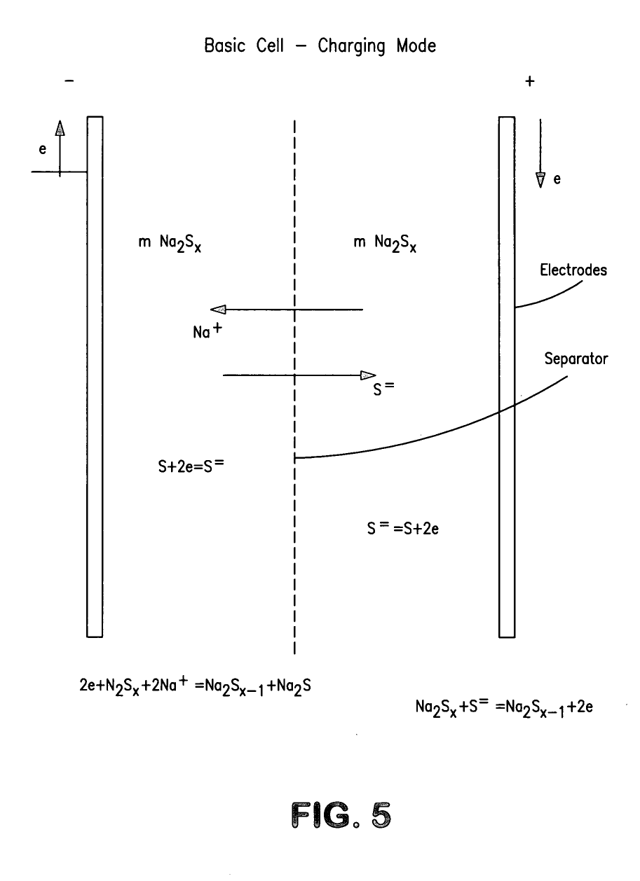

at both electrodes as a means of obtaining widely disparate concentrations of sulfide ions. The electrolyte is an aqueous, or other suitable solvent such as alcohol, solution of an alkali sulfide salt such as (NH₄)₂S, Na₂S, or K₂S. Since sulfur is solubilized as a complex by such sulfide salts, the cell can be operated in a concentration region where there are no solids present during normal operation. FIG. 5, shows the cell process at each electrode for sodium sulfide electrolyte.

In FIG. 5 a microporous membrane with no ionic selectivity is shown as the separator between (−) and (+) electrolytes. In this instance both Na⁺ as well as S⁻² ions are shown as migrating in opposite directions as dictated by the electrical polarity of the electrodes. The rate of such transport for these ions is determined by their respective mobility through the solutions.

The polysulfide, Na₂Sₓ, is the state common to both sides of the cell at the totally discharge stage. There are m-moles of each compound in solution on each side. When charging begins higher polysulfides are generated at the (+) electrode, and lower sulfides are produced at the (−) electrode. If posilyte and negalytes have equal volumes then at full charge the (+) side will have a saturated solution of the maximum solubilized sulfur, or Na₂S₅ as electrolyte, and the (−) side will be a maximum concentration of Na₂S electrolyte.

If the concentration of the (+) side is greater than that of the (−) side, or if the volume were greater of the (−) side, then at full charge some free, solid sulfur may be deposited onto the (−) electrode surfaces.

### General Cell Characteristics

The primary reason for pursuing a cell of this type is its long life and maintenance free operation. Since both sides of the cell contain the same chemical species, there is no possibility of degradation of performance or structure with time or cycling. The electrical potential in the cell is derived from the difference in concentration of one chemical specie. In this instance it is the sulfur/sulfide “half couple”. Initially (cell in the “discharged state”) the concentrations of sulfide ions are the same on either side of the cell. Each side is separated from the other by a microporous or ion selective membrane. Concentration of elemental sulfur at electrodes is irrelevant to the production of cell potential. Activities of solids and unionized species are taken as unity.

Attributes of the cell include: Benign chemical environment, no maintenance, unlimited shelf life, unlimited cycle life, no gas production, maintaining control of charging potentials provides for a versatile system for a sealed unit design, very inexpensive and abundantly available chemical reagents, and cell construction is simple and inexpensive insensitive to electrical polarity.

Electrolyte Information

Regarding electrolyte choice, the three salts cited earlier have high solubility in water as well as in alcohols as well as in many other non-aqueous solvents. Some data are provided below.

| | Molecular | Solubility | | Resistivity |
|---|---|---|---|---|
| Salt | Weight | gm/liter | | ohm-cm |
| Na₂S | 78 | 200 to 500 | g/L | 4 to 8 |
| K₂S | 110 | >800 | g/L | 3 to 6 |
| (NH₄)₂S | 68 | >1000 | g/L | 6 to 10 |

If the reagents are to be soluble at all times, then at the beginning of discharge the electrolytes are:

(+) side Na₂S₅∥5 Na₂S (−) side

As discharge proceeds, (assuming only Na⁺ ions are transported), compositions of each cell side, become, as indicated in the following steps, all the way up to reverse total charge. The flow of electrons during “discharge” in such a symmetrical cell is from the negative electrode to the external load, and when zero potential is reached when the same concentrations of S⁼ ions exist at each electrode the flow of electrons stops.

There are 26 AH of charge per liter per gram equivalent weight. Thus, there are 156 AH(amp-hours) transferred for the 6 moles of sodium ions. This corresponds to 0.156 AH/cc of total electrolyte, or about 9.36 AM per cc. For a cell with 1 in² electrode area and a total spacing of 0.020 in design, then its electrolyte volume would be 0.020 in³=0.328 cc. This cell would then have a charge capacity of 9.36 AM(amp-minutes)/cc×0.328 cc=3.07 AM

Higher capacities can be achieved if the polymerization of sulfur can be made to proceed further, or if free sulfur is allowed to accumulate.

### S/S⁻² Cell Balance Analysis

Another more direct and simple method of showing the materials balance and estimating the energy density of a concentration cell is that shown below for the sulfur/sulfide cell. We can assume that the process will no longer be limited to the maximum amount of sulfur that the polysulfide can solubilize. As an idealized example, the initial condition for a fully charged cell is Na₂S∥S, or more generally, aNa₂S∥bS, where a and b are whole numbers of moles. In order for the process to balance at zero charge (complete discharged) state, a=b, and a>1.

One can now compute the maximum charge stored per unit weight of reactants in this concentration cell. If the simplest example is taken it would be 2Na₂S∥2S at full charge, and Na₂S∥Na₂S+S at total discharge with a transfer of 50 AH per total molecular weight of reactants.

This amounts to 2(78)+(32)=188 gm with a charge transfer of 50 AH giving as energy density 50 AH/188 gm×454 gm/lb=120 AH/lb of dry materials

It is possible to further generalize the analysis for the cell processes wherein the sulfur is always attached to, complexed, with the sodium polysulfide molecules. Since the details of interim stages of complexing cannot be readily known, we will assume the following steps in the charge transfer and discharge of a cell that begins with the polysulfide on one side and the mono-sulfide on the opposite side. Let us take the penta-sulfide as the largest size complex available. The cell configuration and reactions become those shown below.

Starting with the fully charged state as before, but with the bi-sulfide on one side and the mono-sulfide on the other, aNa₂S μ bNa₂S₂

The smallest value for a is 3 since it is necessary to remove two 2Na atoms from the mono-sulfide to meet the conditions of no free sulfur on either side of the cell. Without going through the approximation sequences, the numerical ratio that results functions to make both sides of the cell identical after discharge is

a=3

b=2

3Na₂S∥2Na₂S₂ Charged

Na₂S+Na₂S₂∥2Na₂S+Na₂S₂ Discharged

The total gram molecular weight of both sides is 234+220=454. And the charge transferred by 2Na⁺ ions is 50 AH. The charge density of dry salt is simply

50 AH×454 gm/lb/454 gm=50 AH/lb

If we start out with the tri-sulfide, the reaction balance, etc. are;

aNa₂S∥bNa₂S₃ Charged

a=3

b=1

3Na₂S∥Na₂S₃

Na₂S+Na₂S₂∥Na₂S+Na₂S₂

Total weight=3×78+142=376. And the charge density=50 AH×454/376=60 AH/lb
The cell reaction making use of the next higher initial polymer of sulfur and sulfide is

aNa₂S∥bNa₂S₄

a=5

b=1

5Na₂S∥Na₂S₄

3Na₂S+Na₂S₂∥Na₂S+Na₂S₃

Na₂S+2Na₂S₂∥2Na₂S+Na₂S₂

Total weight is 390+174=564. Since there are four Na⁺ ions transferred from fully charged to symmetrical distribution of ions at discharge, the charge density is 100×454/564=80 AH/lb.

Taking the penta-sulfide as the last or highest complex, the cell parameters become;

aNa₂S∥bNa₂S₅

a=7

b=1

7Na₂S∥Na₂S₅

5Na₂S+Na₂S₂∥Na₂S+Na₂S₄

3Na₂S+2Na₂S₂∥2Na₂S+Na₂S₃

Na₂S+3Na₂S₂∥3Na₂S+Na₂S₂

Total weight is now 546+206=752. There are three transfers of 2Na⁺ ions, hence the charge density is now 150 AH×454/752=90 AH/lb.

If it is possible in a practical cell to utilize higher complexes the charge density would merely approach the maximum value of 188 AH/lb at one volt operating potential per cell. In order to compute the energy density of such cells it is necessary to multiply the charge density by an appropriate voltage. Since the cell potential is so dependent upon the state of charge a reasonable value of working cell voltage over the entire range of charge storage would be half of the full open circuit voltage of 1.0 to 1.2 volts, or about 0.5 to 0.6 volts. Hence, the maximum energy density of the cell, assuming no water (solvent) weight or other contributions to inefficiencies would be about 60 to 66 WH/lb of reactants. The operating open circuit potential is purposely limited to between 1.0 and 1.2 volts to prevent the evolution of hydrogen gas at electrode surfaces. H₂ evolution would necessitate the periodic readjustment of electrolyte composition, necessitate venting of cells, and would eventually result in mechanical erosion of electrodes. Another approach to preventing gas generation at electrodes is the employment of non-aqueous solvents such as absolute alcohol, pyridine, DMSO and nitrites

### Concentration Cell Employing Fe⁺2/Fe⁺³

The present invention is not restricted to the use of sulfur and its numerous polysulfides such as those of potassium, ammonium, lithium, etc. In fact the above concentration cell approach to energy storage can make use of numerous other materials with properties such as solubility, conductivity, stability, and costs suitable to practical methods of implementation. Some materials have different characteristics that may make them more suitable for applicable to certain uses. These materials include the use of the elements iron, bromine, iodine, and chromium. Their well behavior as electrochemical species are well known and readily available.

The balance relations for the iron concentration cell are as follows. The charge carrier within the cell is the hydrogen ion. The hydrogen ion is a much more mobile ion and gives lower resistance to the cell than it would have if the iron ions were the principal carriers. The cell is amenable chemically to high acidity since there are no materials on construction or metallic depositions present that might be attacked in very low pH situations.

One can make use of the two oxidation states of iron, Fe⁺² and Fe⁺³ ions. Their solubility is such that high concentrations (two to four molar) of these are easily attained in water. Potentials during charge must be kept below that for the formation of free iron, Fe⁰. That potential in water solutions is about 1.2 volts. The reaction of interest to us here is of the form

aFeCl₂+bHCl∥cFeCl₃+dHCl fully charged state.

The charge carrier is the hydrogen, H⁺, in this cell. A cation exchange membrane, or a microporous separator is employed in this cell. In order for the reaction to proceed and have a symmetrical situation on both sides of the separator, i.e. no further oxidation/reduction energetics remain, the minimum values for the coefficients a, b, c, and d are 2, 1, 2, and 1. Thus the initial and final states are

2FeCl₂+HCl∥2FeCl₃

FeCl₂+FeCl₃∥FeCl₂+FeCl₃+HCl

There is only one charge carrier per such step. Hence, the total weight of reagents is 252+36+322=910 gm. The charge density is then 25 AH×454/910=13 AH/lb

Even though the energy density is not as attractive as that of the sulfide system, there are some outstanding features such as extremely low cost of materials, low hazard and no chance of solids deposition, if potentials are kept below that for

Fe⁺²+2e⁻→Fe⁰,

the reduction of ferrous to metallic iron plating. That potential is approximately 1.2 volts at normal conditions.

The concentration potentials that are expected and achieved experimentally for the ferrous/ferric cell are expressible in terms of specific iron concentrations at the respective electrodes. This provides us with a first approximation of the voltage versus concentration differentials.

The electric potential may be put into terms specific to the iron concentration cell. At any point in the charge or discharge of this cell there will be a concentration [Fe⁺²] of ferrous ions, and a concentration [Fe⁺³] of ferric ions at the positive electrode. Similarly there will be concentrations of ferrous and ferric ions respectively, [Fe⁺²] and [Fe⁺³] at the negative electrode.

The resultant concentration potential between the two electrodes can be approximated as equal to

$$E = {E}_{0} - \frac{RT}{zF} ln \{ \frac{{{[ {Fe}^{+ 3} ]}_{+} [ {Fe}^{+ 2} ]}_{-}}{{{[ {Fe}^{+ 3} ]}_{-} [ {Fe}^{+ 2} ]}_{+}} \}$$

Since the charge carrier and the oxidation state change by a charge of only one, z=1, and the above expression becomes

$$E = 0.06 ln \{ \frac{{{[ {Fe}^{+ 3} ]}_{+} [ {Fe}^{+ 2} ]}_{-}}{{{[ {Fe}^{+ 3} ]}_{-} [ {Fe}^{+ 2} ]}_{+}} \} volts$$

Or, expressing (24) as the difference in the logarithms of the concentrations,

$$E = 0.06 ln \{ \frac{{[ {Fe}^{+ 3} ]}_{+}}{{[ {Fe}^{+ 3} ]}_{-}} + \frac{{[ {Fe}^{+ 2} ]}_{-}}{{[ {Fe}^{+ 2} ]}_{+}} \} volts$$

To attain a cell potential of 1 or more volts the concentration ratio product must be in the range of 10¹⁰ or greater.

### The Br2/Br⁻¹ Cell

The balance of materials for a concentration cell with bromine as the element undergoing oxidation/reduction is another example shown below.

| | |
|---|---|
| 4NaBr // 2Br₂ | fully charged cell |
| 2NaBr + Br₂ // 2NaBr + Br₂ | discharged, symmetrical cell |

Total gram molecular weight is 412+164=576. Two sodium ions are transferred in this transition to symmetry through a cation membrane with the charge capacity becoming 50 AH×454/576=40 AH/lb of reagents. The advantage of this system is the somewhat higher energy density and the fact that bromine and bromides are very well behaved electrochemical species. However, the problems of materials compatibility and bromine storage remain deterrents to its practical use.

Regarding electrodes, my previous U.S. Pat. No. 5,422,197, carbon (Grafoil) can be used as intermediate electrodes in series bipolar arrays.

At a resistivity of 10-3 ohm-in for graphite the resistance of a ¼ inch thick sheet 10 inches wide and 20 inches long that might be employed in as end plate electrodes would be 10⁻³×20/10×0.25=8×10⁻³3,920,474, 4,053,684, 4,069,371 and 4,117,204 incorporated herein by reference as though set out at length herein, give details for fabrication of conductive backing sheets and porous carbon surfacing for zinc/bromine and iron/redox cells. The electrodes developed for the zinc bromine and iron redox systems are equally applicable to all of the above concentration cells described here. In addition to this, commercially available graphite plates (impregnated or merely dense structures) can be employed as the conductive substrates for all systems except for the bromine concentration cell. In some instances exfoliated ohms. A typical electric current of 10 amps down the length of the electrode would experience an averaged drop of 10 amps×½×0.008=0.04 volts. In a cell with 1 volt open circuit 0.04 volts drop is acceptable. If the end-plate graphite were only the end plates in a series array of 10 or 20 or more cells, the voltage drop would be entirely negligible.

Most electrodes used in the sulfide/polysulfide cells are either pressed graphite/binder substrates or dense graphite plates with loose charcoal held in place against them. Performance is predictable and utilization of reagents approaches over 80%. These types of cells are equally effective in the iron and bromine cells, with bromine stored in porous carbon on both sides of the cation membrane in static electrolyte cells. Carbon felt pads pressed against conductive substrates performed well for all systems except the sulfur cells. Polysulfide quickly forms free sulfur between the felt pad and the substrate making the cell resistance increase many fold almost immediately upon passage of an electric current.

### Properties of Microporous Carbon

Between 1,000 and 1,500 square meters of carbon surface area is measured by the producers of active carbon. That amounts to carbon structures with walls no greater than one or two atomic diameters thick. Almost all of this is available for bromine adsorption, and it appears most for storage of sulfides, iron salts, etc. There is an optimum thickness for each of these for storage. For sulfides it appears to be about ¼ inch thick (loose cocoanut, UU grade carbon). Beyond that the utilization factor diminishes rapidly. Void volumes of these carbons are in the order of 75%, and their bulk density is less than 1 gm/cc.

Use of carbon felt pads is possible with iron, but not with sulfides—unless pads are well bonded and electrical continuity is established with the conductive substrate. Sulfur is plated off on the carbon plate immediately between the pad and the substrate resulting in very high cell resistance.

Most electrodes used in the sulfide/polysulfide cells are either pressed graphite/binder substrates or dense graphite plates with loose UU charcoal held in place against them. Performance is predictable and utilization of reagents approaches over 80%. These type of cells are equally effective in the iron and bromine cells, with bromine stored in porous carbon on both sides of the cation membrane in static electrolyte cells. Carbon felt pads pressed against conductive substrates performed well for all systems except the sulfur cells. Polysulfide quickly forms free sulfur between the felt pad and the substrate making the cell resistance increase many fold almost immediately upon passage of an electric current.

### Charging Methods

Since it is necessary to prevent the formation of any gasses during charging of cells a problem exists in charging multiple cells in series electrically. A single cell may be charged reliably with a voltage and current limited dc power supply. For maximum energy efficiency it is recommended that charging and discharging are performed at constant current. When many static electrolyte cells are electrically in series it becomes necessary to resort to either of three methods of charging. They are;

1. Sequential charging. Electrical connections are made to all cells in an array and only one cell is being charged at any time. The charging circuit sequentially charges each cell in turn for either a predetermined amount of time or until the maximum voltage is attained.

2. Periodic open circuit examination. The charging circuit would place the entire array on open circuit for a very brief time period while the charger scans the cells to see if any are close to the maximum potential, or are experiencing abnormally high charging voltages. Circuitry would stop the charging process so that the cause of imbalance can be determined.

3. Cells can be charged in parallel and discharged in series electrically.

### EXAMPLE-1

Empirical performance data for the sulfide and iron cells are given in the following figurers.

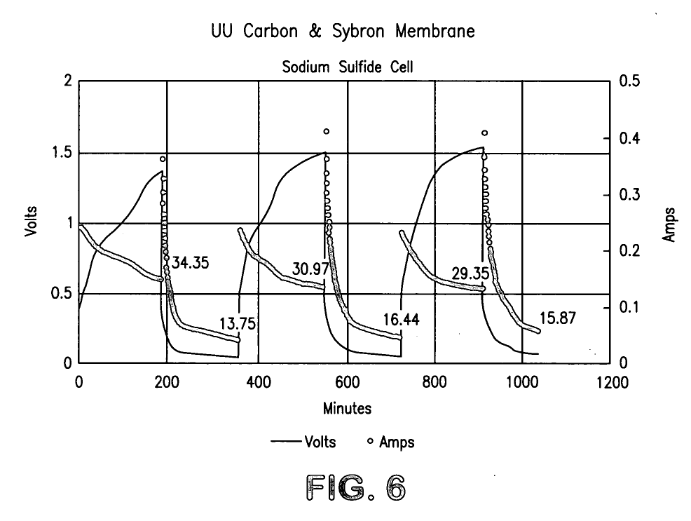

FIG. 6 describes a few of a series of over 1,000 cycles put onto a sulfide cell with electrode area of 4 square inches and spacing of 0.20 inches on either side of a Sybron cation membrane. The reagents are stored at the electrode sites consisting of coconut, UU grade charcoal, loosely compacted between the electrodes and membrane. Reproducibility and consistency of cycling is noted. Active flat area of membrane and electrodes is 4 in².

### EXAMPLE-2

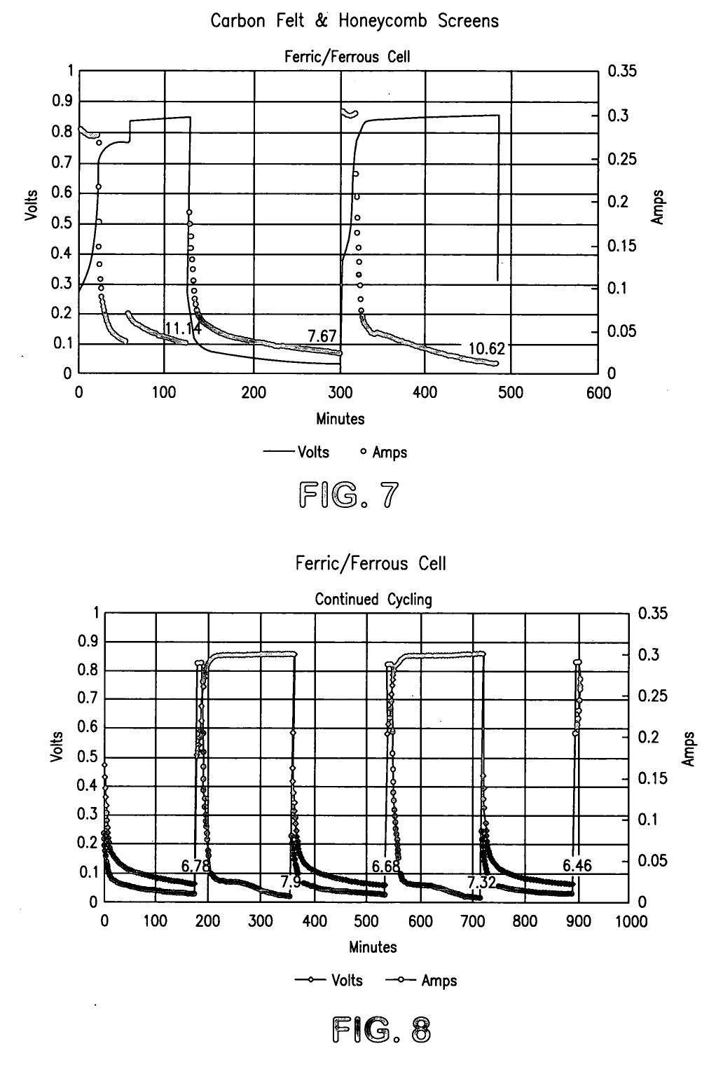

FIG. 7 shows two cycles for an iron concentration cell employing carbon felt pads mechanically laying against each of the two electrodes. A plastic (honeycomb structure) screen is between the felt pads on both sides to permit introduction of electrolyte in to cell after assembly. A sheet of RAI. Co. homogeneous polyethylene cation transport membrane referenced as ESC type. Electrode plate area is about 5 in². The cycles, over 1200, are almost indistinguishable from each other in performance, and with no observable degradation.

FIG. 8 shows the continued cycling of the same cell-B to indicate the cycle reproducibility of electrical data. These last four cycles represent over 1,00 total energy events for that cell when discharging at constant resistive load.

### EXAMPLE-3

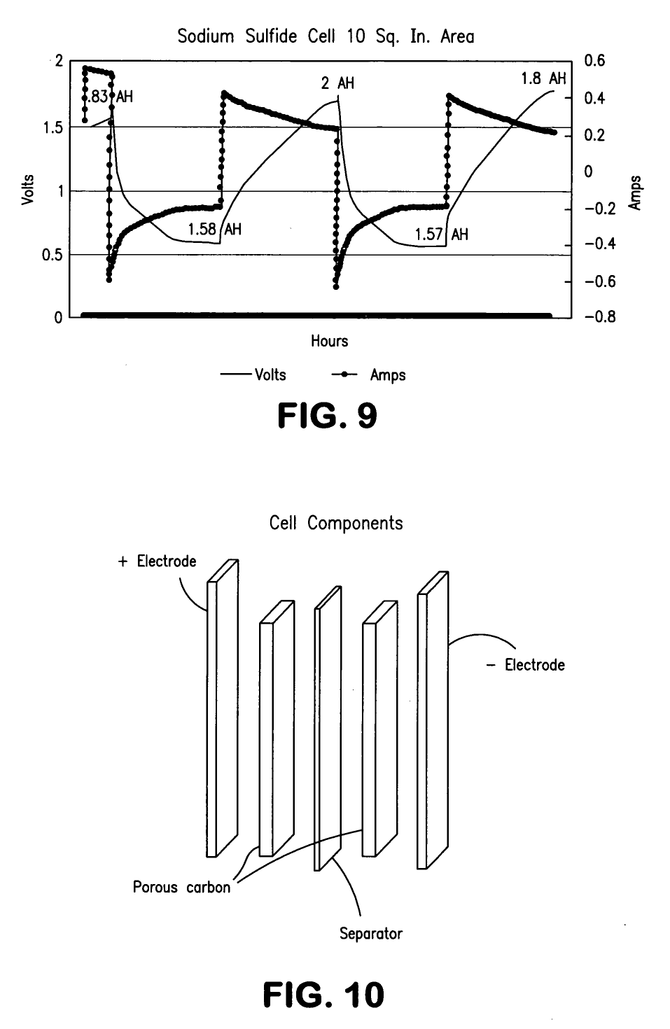

More experimental data with sulfide cells are presented in the next graph. A cell is constructed, FIG. 9, employing Sybron (cation) membrane as separator principally to eliminate any electronic contact between charcoal particles on opposite electrodes. This cell has a flat electrode area of about 10 in² and electrode plate separation of 0.5 in. The figure shows charge-discharge electrical characteristics while maintaining constant resistive load during discharge. The total (x-axis length) time for the cycling as shown in the graph is 25 hours. The reproducibility of characteristics from one cycle to the next is again demonstrated.

Details of Cell Fabrication

Construction of concentration cells is very similar to that of many electrochemical devices. In principle they consist of two electrodes, an internally intervening electrolyte and a physical separator that permits transport of ions for electrical conduction while presenting maximally obstructing flow or mixing of electrolyte from one electrode compartment to the opposite side.

This general approach to simple, single cell construction is schematically shown in FIG. 10, where parallel plate electrodes are separated by a membrane or porous material between the two electrolyte compartments.

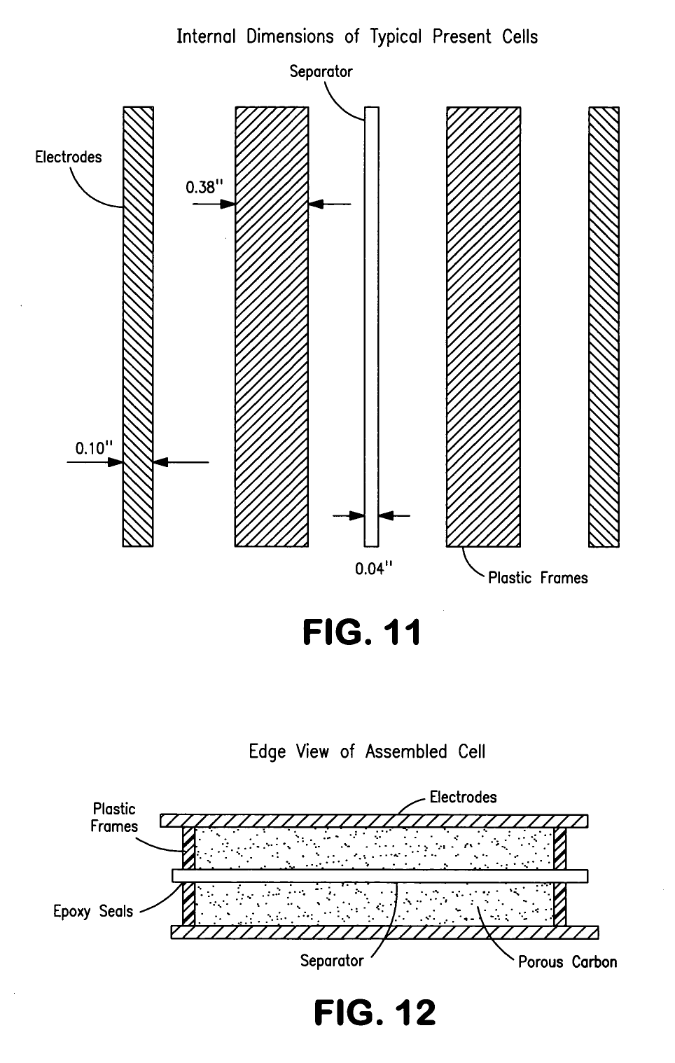

One practical method of constructing a single cell that has been successfully employed for laboratory testing as well as for extensive prototype testing purposes is shown in the exploded view of FIG. 11. Two plastic frames are used to provide for physical rigidity and to define the electrolyte regions. The electrolyte space is filled with microporous carbon particles, in this case they are loose, un-bonded and slightly compressed against the separator and electrodes to establish adequate electrical contact to both electrodes.

FIG. 12 is an edge view of the cell showing electrolyte filled carbon particles confined to the space between separator and electrodes by a plastic (PVC, ABS) frame bonded to the electrodes and separator.

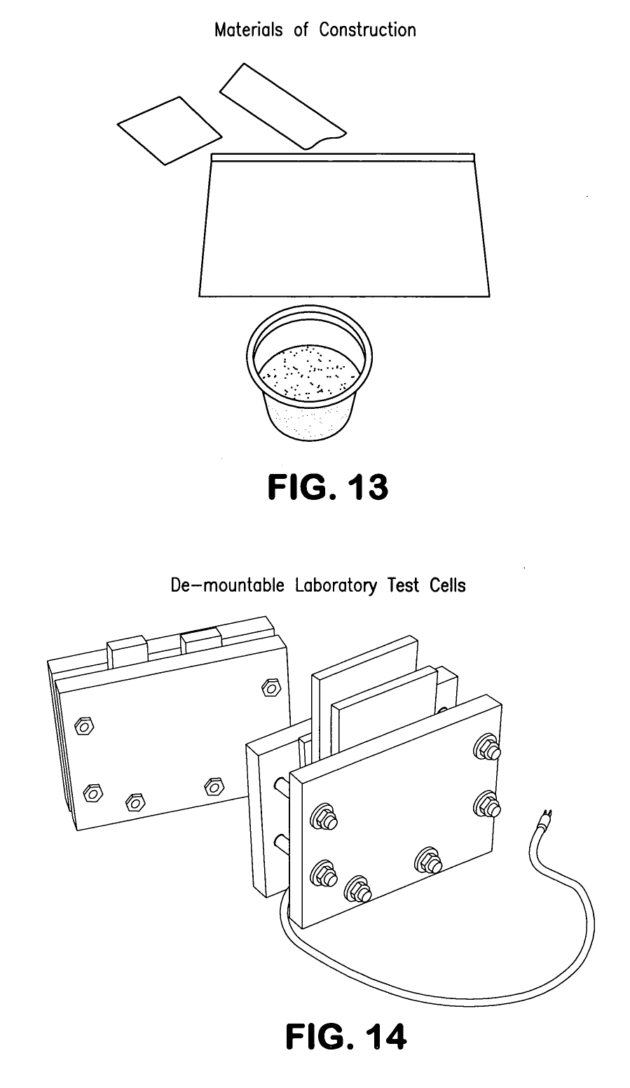

FIGS. 13-14 are photographs of the two principal material components of a cell, i.e., the graphite-polymer composite electrode, and the carbon particles (coconut UU type charcoal) shown in a plastic cup.

Some test cells for laboratory exploration of materials behavior and cell geometry design are assembled with open tops (frames with only three closed sides) to enable observation of electrolyte level changes during cycling as well as general physical characteristics. These laboratory cells are de-mountable design wherein the components of electrodes frames and end plates are clamped together by an array of metal bolts well outside the working area of the cell to enable easy changes in frame thickness, electrolyte concentrations, and membrane type evaluation.

Engineering prototypes can be assembled in a sealed, permanent manner that would not later be disassembled. It is of minimal size and is very similar to the construction shown in FIGS. 10, 11 and 12 with modifications to insure dependable bonding and encapsulation. The frames, electrodes and separator are perforated along the outer edges to provide improved bonding to each of these components. A cement, epoxy agent or glue is employed to bond and mechanically anchor the components together through the provided perforations the components together.

The steps involved in the fabrication are as follows;
1. An electrode lying horizontally is bonded to a frame.
2. The porous carbon particles are mixed with the electrolyte to form a paste-like constituency.
3. The paste mix is troweled into the tray formed by the frame and filled to the height of the frame.
4. The membrane (separator) is bonded to the frame
5. A second frame is bonded to the separator
6. Porous carbon particle paste is again troweled into the volume provided by the second frame
7. The second electrode is bonded to the second frame
8. If one wishes to fabricate a multi-cell array with bipolar electrodes, the operations listed above are repeated as many times as necessary to stack up required number of cells per array.
9. The entire assembly can now be placed into a prefabricated container and a casting compound (polyester, or epoxy) as a final packaging step and electrical leads of whatever type for the two end electrodes can be included in the casting for mechanical strength.

It will now be apparent to those skilled in the art that other embodiments, improvements, details, and uses can be made consistent with the letter and spirit of the foregoing disclosure and within the scope of this patent, which is limited only by the following claims, construed in accordance with the patent law, including the doctrine of equivalents.

1. An electrochemical storage/discharge device with anode and cathode electrodes with one or more cells of the battery array of cells and electrolyte of a single chemical species in separate anolyte and catholyte compartments separated by an ionic transfer structure and means for effecting variation of ionic concentration in one or both of the anolyte and catholyte compartments to effect charge and discharge.

2. The apparatus of claim 1 constructed and arranged for storage within the cell of reactive materials, the materials comprising: S (sulfur), and S⁼, (sulfide ions) in porous carbon electrode structures being constructed with impervious backing sheets and porous carbon particles adhered to, or in intimate contact with the sheet surfaces, with thickness of the porous carbon made in relation to target t upon the capacity per unit area of cell.

3. The apparatus of claim 2 wherein the porous carbon is selected from the group consisting of cocoanut, charcoal, and PCB and OL and synthetic charcoals, the pore size being selected to provide minimum path length distances to the electrolyte for ready access to the reagents.

4. The apparatus of claim 1 wherein the electrodes are all carbon bonded by a polymer.

5. The apparatus of claim 4 wherein the polymer is selected from the group PE, PP, PVC.

6. The apparatus of claim 1 wherein the negative and positive electrolytes are kept separated by a microporous or ion selective membrane between the porous carbons on opposite electrodes.

7. Method for accumulation and storage of energy in a reversible manner by effecting solution concentration differences of common specie solutions in separate zones with an ion transport interface and utilizing electrodes to impose a voltage for charging by imposing the concentration difference for energy storage accumulation and alternatively imposing a load for discharge of the accumulated energy by dissipation of the concentration differences.

8. The method of claim 7 wherein the storage is effected at least in part by exceeding solubility limit so that solute can be stored in solid form in the charging mode and redisolved in discharge mode.

9. The method of claim 8 wherein the solid is stored in a high surface area porous or honeycomb structure.
